(19) United States
(12) Patent Application Publication
(10) Pub. No.: US 2013/0195415 A1
(43) Pub. Date: Aug. 1, 2013

(54) DETACHABLE OPTICAL FIBER GUIDES FOR SPLICE CONNECTOR INSTALLATION TOOLS, AND RELATED ASSEMBLIES AND METHODS

(71) Applicants: Brandon A. Barnes, Ft. Worth, TX (US); Joseph R. Herridge, Ft. Worth, TX (US); Michael G. Thornton, JR., Keller, TX (US)

(72) Inventors: Brandon A. Barnes, Ft. Worth, TX (US); Joseph R. Herridge, Ft. Worth, TX (US); Michael G. Thornton, JR., Keller, TX (US)

(21) Appl. No.: 13/362,474

(22) Filed: Jan. 31, 2012

(51) Int. Cl. G02B 6/00; B23P 11/00

(52) U.S. Cl. 385/135; 29/428

(57) ABSTRACT

Detachable optical fiber guides for splice connector installation tools, and related assemblies and methods are disclosed. The detachable optical fiber guides may be employed to help guide an optical fiber into a fiber optic connector attached within a splice connector installation tool. The detachable optical fiber guides may also be employed to better view the optical fiber, and also to reduce debris and damage to the optical fiber while being inserted into the fiber optic connector. The detachable optical fiber guides may include features to allow the detachable optical fiber guide to be installed toollessly upon the splice connector installation tool for convenient installation, and subsequent removal.

### RELATED APPLICATION

This application is related to U.S. patent application Ser. No. ______, filed on even date herewith and titled “Optical Fiber Guide Apparatus For Splice Connector Installation Tools, and Related Assemblies and Methods,” which is incorporated herein by reference in its entirety.

### BACKGROUND

1. Field of the Disclosure

The technology of the disclosure relates to terminating fiber optic mechanical splice connectors to an optical fiber, and more particularly, to a splice connector installation tool and fiber optic mechanical splice connectors containing stub optical fibers.

2. Technical Background

Optical fibers are useful in a wide variety of applications, including the telecommunications industry in which optical fibers are employed for voice, data and video transmission. With the ever increasing and varied use of optical fibers, apparatus and methods have been developed for coupling optical fibers to one another outside the controlled environment of a factory setting, commonly referred to as “field installation” or “in the field,” such as in a telephone central office, in an office building, and in various types of outside plant terminals. However, in order to efficiently couple the optical signals transmitted by the fibers, a fiber optic connector must not significantly attenuate, reflect or otherwise alter the optical signals. In addition, fiber optic connectors for coupling optical fibers must be relatively rugged and adapted to be connected and disconnected a number of times in order to accommodate changes such as moves, adds, and changes in the optical transmission path that may occur over time.

Although fiber optic connectors are most efficiently and reliably mounted upon the end portion of an optical fiber in a factory setting, it is often desirable to install fiber optic connectors in the field. In other words, the end user can install the fiber optic connector on the end portion of an optical fiber in the field. Installing fiber optic connectors in the field can advantageously minimize cable lengths and optimize cable management and routing. In this regard, installation tools have been developed to facilitate the splice termination of one or more optical fibers to a fiber optic connector, and particularly, to enable the splice termination of one or more field optical fibers to a mechanical splice connector. Examples of conventional installation tools for performing mechanical splices in the field are described in U.S. Pat. Nos. 5,040,867; 5,261,020; 6,816,661; and 6,931,193. In particular, U.S. Pat. Nos. 6,816,661 and 6,931,193 describe a UNICAM® installation tool available from Corning Cable Systems LLC of Hickory, N.C., designed specifically to facilitate mounting the UNICAM® family of fiber optic connectors upon the end portions of one or more field optical fibers.

FIGS. 1A and 1B respectively illustrate an exemplary field-installable, mechanical splice fiber optic connector 10 (also referred to as “mechanical splice connector” and “fiber optic connector 10”) suitable for use with the installation tool before and after termination. The fiber optic connector 10 may be a member of the UNICAM® family of mechanical splice connectors. As shown in FIGS. 1A and 1B, the mechanical splice connector 10 includes a connector ferrule 12 defining a lengthwise, longitudinal bore for receiving and securing a stub optical fiber 14 in a known manner, such as by an adhesive. The forward end 16 (also referred to herein as the end face) of the ferrule 12 is typically precision polished such that the stub optical fiber 14 is flush with (as shown) or slightly protruding from the end face 16 of the ferrule 12. The rear end 18 of the ferrule 12 is inserted into and secured within the forward end of a ferrule holder 20 so that the stub optical fiber 14 extends rearwardly a predetermined distance from the ferrule 12 between a pair of opposed splice components 22, 24 disposed within the ferrule holder 20. In turn, the ferrule holder 20, including the ferrule 12 and splice components 22, 24, are disposed within a connector housing 26.

With continuing reference to FIGS. 1A and 1B, a cam member 28 is movably mounted to the ferrule holder 20 and the connector housing 26 for engaging a keel portion of the lower splice component 24. If desired, the ferrule 12, the ferrule holder 20 and the cam member 28 may be biased relative to the connector housing 26, for example by a coil spring 30, to ensure physical contact between the end face 16 of the ferrule 12 and the end face of an opposing ferrule in a mating fiber optic connector or optical device (not shown). Finally, a spring retainer 32 may be disposed between the connector housing 26 and a medial portion of the cam member 28 and fixed to the connector housing 26 so as to retain one end of the spring 30 relative to the connector housing 26. As a result, the ferrule 12, the ferrule holder 20 and the cam member 28 are biased forwardly, yet permitted to piston rearwardly relative to the connector housing 26.

To make a splice within a connector, a field optical fiber 34 is inserted into a rear end of the ferrule holder 20 opposite the ferrule 12 and the stub optical fiber 14 as illustrated by the horizontal directional arrow A_{H} in FIG. 1A. Typically, the field optical fiber 34 is coated or tight-buffered with a buffer 36 that is stripped back to expose a predetermined length of the end of the field optical fiber 34. The mechanical splice connector 10 may be further provided with a crimp tube 38 for retaining and strain relieving the buffer 36 of the field optical fiber 34. With a portion of the buffer 36 removed, the field optical fiber 34 can be inserted and advanced into the rear of the mechanical splice connector 10 between the splice components 22, 24 until the end portion of the field optical fiber 34 makes physical contact with the end portion of the stub optical fiber 14. Thereafter, the cam member 28 is actuated by moving or rotating the cam member 28 relative to the ferrule holder 20 about the longitudinal axis of the connector 10, to engage the keel on the splice component 24 and thereby force the lower splice component 24 in the direction of the upper splice component 22. Movement of the lower splice component 24 causes the end portion of the stub optical fiber 14 and the end portion of the field optical fiber 34 to seat within the V-shaped groove formed in the lower splice component 24, thereby aligning and securing the field optical fiber 34 relative to the stub optical fiber 14 between the splice components. Accordingly, the field optical fiber 34 is optically coupled to the stub optical fiber 14 as a mechanical splice for transmitting an optical signal between the field optical fiber 34 and stub optical fiber 14.

To make an acceptable mechanical splice, a clean and undamaged optical fiber 34 should be inserted into the fiber optic connector 10 for achieving a satisfactory termination with the stub optical fiber 14 within the connector. A conventional practice is to insert the optical fiber 34 manually within the fiber optic connector 10 in the installation tool by aligning the optical fiber 34 with a crimp tube of the fiber optic connector 10. This conventional practice is generally sufficient for highly-trained and experienced technicians; however, less experienced technicians may lack the know-how and/or have difficulty making high-quality termination in the field. Moreover, the conventional practice typically includes re-cleaving a damaged optical fiber 34 and/or cleaning optical fibers 34 contaminated with debris when the optical fibers 34 are not properly inserted in the fiber optic connector 10 on the first attempt. In other words, depending on the skill, eyesight, and dexterity of the technician, as well as ambient light, alignment and insertion of the optical fiber 34 in the fiber optic connector 10 may require more than one attempt. Consequently, there is an unresolved need for devices and methods that provide high-quality terminations in the field by the technician.

### SUMMARY OF THE DETAILED DESCRIPTION

Embodiments disclosed herein include detachable optical fiber guides for splice connector installation tools, and related assemblies and methods. The detachable optical fiber guides may be employed to guide and/or self-align an optical fiber into a fiber optic connector disposed within a splice connector installation tool. As non-limiting examples, the detachable optical fiber guides may also be employed to better view the optical fiber during insertion, and also to reduce debris and damage to the optical fiber while being inserted into the fiber optic connector. The detachable optical fiber guides may include optional features to allow the detachable optical fiber guide to be installed and detached toollessly upon and from the splice connector installation tool for convenient installation, and subsequent removal. Optical fiber discussed herein includes one or more optical fibers whether disposed in a common cable jacket or disposed freely of each other outside a cable jacket.

In this regard in one embodiment, a detachable optical fiber guide apparatus is disclosed for guiding a field optical fiber (hereinafter “optical fiber”) into a fiber optic connector installed (i.e., held) within a splice connector installation tool. The detachable optical fiber guide apparatus includes a fiber guide configured to receive and guide an optical fiber and an attachment member supporting the fiber guide. The attachment member may be configured to be attached to a splice connector installation tool to align the fiber guide with a fiber entry of the fiber optic connector installed within the splice connector installation tool. The fiber guide may comprise a recess defining an exit opening having a first cross-sectional area. The fiber guide may also include an entry opening opposite the exit opening. The entry opening may have a second cross-sectional area larger than the first cross-sectional area. The exit opening may be configured to be disposed adjacent the fiber entry of the fiber optic connector installed within the splice connector installation tool. The entry opening may be configured to receive the optical fiber and to guide the optical fiber to and through the exit opening into the fiber entry of the fiber optic connector installed within the splice connector installation tool. In this manner, as a non-limiting example, the optical fiber may be inserted through the fiber guide with less debris generation than would otherwise attenuate an optical signal transmitted through a fiber optic connector terminated without using the detachable optical fiber guide apparatus in combination with the splice connector installation tool.

In another embodiment, an optical fiber termination system is disclosed. The optical fiber terminal system includes a splice connector installation tool having a housing forming an internal cavity and a detachable optical fiber guide apparatus. The housing may include a first external surface and a second external surface. The splice connector installation tool may also include a mechanical device which may be at least partially disposed within the internal cavity. The mechanical device may be configured to perform a splice termination of an optical fiber and a stub optical fiber of a fiber optic connector.

Further in this embodiment, the detachable optical fiber guide apparatus may be configured to guide an optical fiber into a splice connector installation tool. The detachable optical fiber guide apparatus includes a fiber guide configured to receive and guide an optical fiber and an attachment member supporting the fiber guide. The attachment member may be configured to be attached to a splice connector installation tool to align the fiber guide with a fiber entry of the fiber optic connector installed within the splice connector installation tool. The fiber guide may comprise a recess defining an exit opening having a first cross-sectional area. The fiber guide may also include an entry opening opposite the exit opening. The entry opening may have a second cross-sectional area larger than the first cross-sectional area. The exit opening may be configured to be disposed adjacent the fiber entry of the fiber optic connector installed within the splice connector installation tool. The entry opening may be configured to receive the optical fiber and to guide the optical fiber to and through the exit opening into the fiber entry of the fiber optic connector installed within the splice connector installation tool. In this manner, as a non-limiting example, the optical fiber may be quickly inserted into the fiber optic connector attached to the splice connector installation tool with less chance of damage to the optical fiber.

In another embodiment, a method for splicing an optical fiber to a stub optical fiber in a fiber optic connector is disclosed. The method may include providing a fiber optic splice connector installation tool comprising a housing and includes providing a detachable optical fiber guide apparatus having a fiber guide and an attachment member. The method may then include aligning the fiber guide with a fiber entry of the fiber optic connector installed within the splice connector installation tool by attaching the attachment member to the fiber optic splice installation tool. The method may also include cleaning the fiber guide and then attaching the fiber guide to the attachment member. The method may then include inserting an end portion of an optical fiber through the fiber guide and into the fiber optic connector. The method may also include terminating the optical fiber to a stub optical fiber of the fiber optic connector. The method may then include removing the detachable optical fiber guide apparatus from the fiber optic splice connector installation tool. In this manner, as a non-limiting example, the optical fiber may be inserted into the fiber optic connector quickly and with minimal operator skill required.

Additional features and advantages will be set forth in the detailed description which follows, and in part will be readily apparent to those skilled in the art from that description or recognized by practicing the embodiments as described herein, including the detailed description that follows, the claims, as well as the appended drawings.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE FIGURES

FIG. 1A is a side cutaway view of an optical fiber prior to termination with a stub optical fiber of an explanatory prior art mechanical splice fiber optic connector;

FIG. 1B is a side cutaway view of the optical fiber terminated with the stub optical fiber of the prior art mechanical splice fiber optic connector of FIG. 1A;

FIG. 2A is a top view and partial cutaway view of an exemplary fiber optic connector installed in an exemplary splice connector installation tool adjacent to an exemplary detachable optical fiber guide apparatus;

FIG. 2B is a perspective view of the detachable optical fiber guide apparatus of FIG. 2A installed on the splice connector installation tool of FIG. 2A and an optical fiber aligned with a fiber entry of the fiber optic connector of FIG. 2A;

FIG. 2C is a front view of the detachable optical fiber guide apparatus of FIG. 2A installed on the splice connector installation tool of FIG. 2A;

FIG. 3A is a front view of the exemplary detachable optical fiber guide apparatus of FIG. 2A;

FIG. 3B is a top view of the detachable optical fiber guide apparatus of FIG. 2A;

FIG. 3C is a left side view of the detachable optical fiber guide apparatus of FIG. 2A;

FIG. 3D is a top view of a fiber guide of the detachable optical fiber guide apparatus of FIG. 2A;

FIG. 3E is a rear view of the fiber guide of the detachable optical fiber guide apparatus of FIG. 2A;

FIG. 3F is a front view of the fiber guide of the detachable optical fiber guide apparatus of FIG. 2A;

FIG. 4 is a side schematic conceptual view of a methodology for measuring the reflectivity of a plating material that may be used for the fiber guide of the detachable optical fiber guide apparatus of FIG. 2A;

FIG. 5 illustrates an exemplary process for splicing the optical fiber to a stub optical fiber in a fiber optic connector of FIG. 2A;

FIG. 6A is a front view of another exemplary detachable optical fiber guide apparatus with a fiber guide of the detachable optical fiber guide apparatus detached from an attachment member;

FIG. 6B is a front view of the detachable optical fiber guide apparatus of FIG. 6A with the fiber guide of the detachable optical fiber guide apparatus attached to the attachment member;

FIG. 6C is a left-side view of the detachable optical fiber guide apparatus of FIG. 6A with the fiber guide of the detachable optical fiber guide apparatus attached to the attachment member;

FIG. 7 is a perspective view of yet another exemplary detachable optical fiber guide apparatus attached on the splice connector installation tool, and the splice connector installation tool was previously depicted in FIG. 2A;

FIG. 8A is a front view of the detachable optical fiber guide apparatus of FIG. 7 with a fiber guide removed for clarity;

FIG. 8B is a top view of the detachable optical fiber guide apparatus of FIG. 7 with the fiber guide removed for clarity;

FIG. 8C is a left-side view of the detachable optical fiber guide apparatus of FIG. 7 with the fiber guide removed for clarity;

FIG. 9 is a perspective view of yet even another exemplary detachable optical fiber guide apparatus attached on the splice connector installation tool, and the splice connector installation tool was previously depicted in FIG. 2A;

FIG. 10A is a front view of the detachable optical fiber guide apparatus of FIG. 9 with a fiber guide removed;

FIG. 10B is a top view of the detachable optical fiber guide apparatus of FIG. 9 with the fiber guide removed;

FIG. 10C is a left-side view of the detachable optical fiber guide apparatus of FIG. 9 with the fiber guide removed; and

FIG. 10D is a top view of the detachable optical fiber guide apparatus of FIG. 9 with the fiber guide attached and showing a range of motion of the fiber guide.

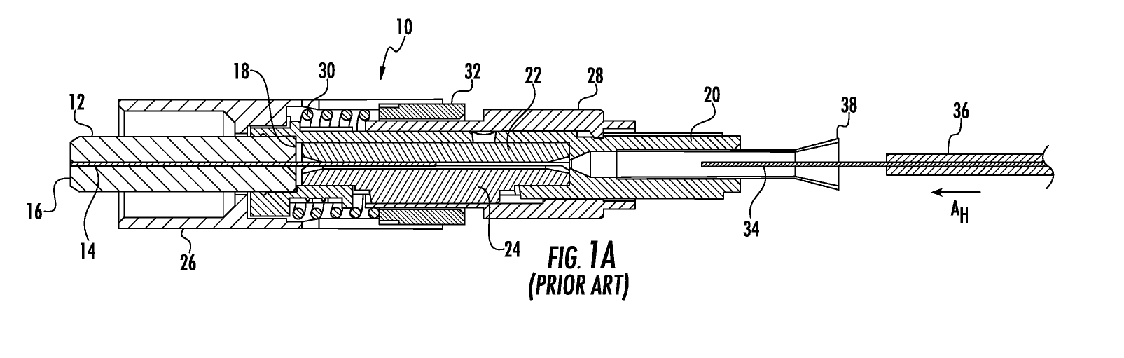

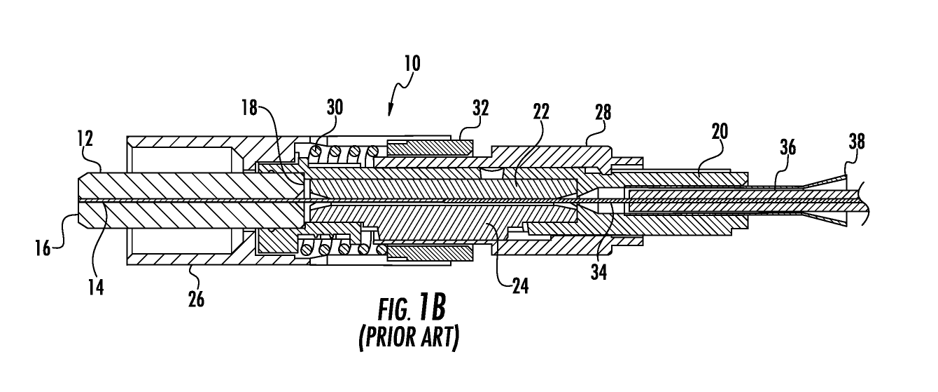

### DETAILED DESCRIPTION

Reference will now be made in detail to the embodiments, examples of which are illustrated in the accompanying drawings, in which some, but not all embodiments are shown. Indeed, the concepts may be embodied in many different forms and should not be construed as limiting herein; rather, these embodiments are provided so that this disclosure will satisfy applicable legal requirements. Whenever possible, like reference numbers will be used to refer to like components or parts.

Embodiments disclosed herein include detachable optical fiber guides for splice connector installation tools, and related assemblies and methods. The detachable optical fiber guides may be employed to guide and/or self-align an optical fiber into a fiber optic connector disposed within a splice connector installation tool. As non-limiting examples, the detachable optical fiber guides may also be employed to better view the optical fiber during insertion, and also to reduce debris and damage to the optical fiber while being inserted into the fiber optic connector. The detachable optical fiber guides may include optional features to allow the detachable optical fiber guide to be installed and detached toollessly upon and from the splice connector installation tool for convenient installation, and subsequent removal. Optical fiber discussed herein includes one or more optical fibers whether disposed in a common cable jacket or disposed freely of each other outside a cable jacket.

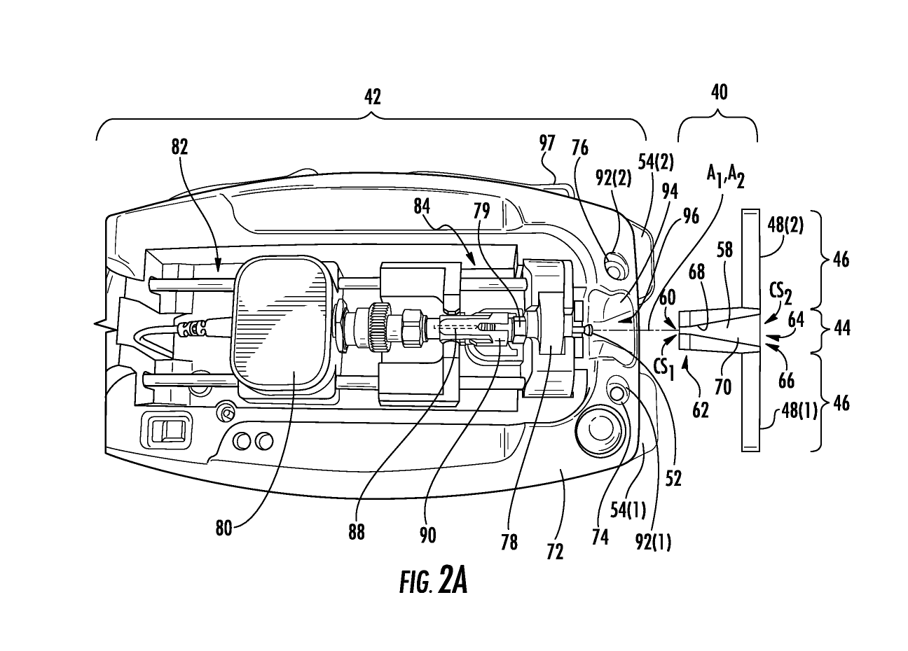

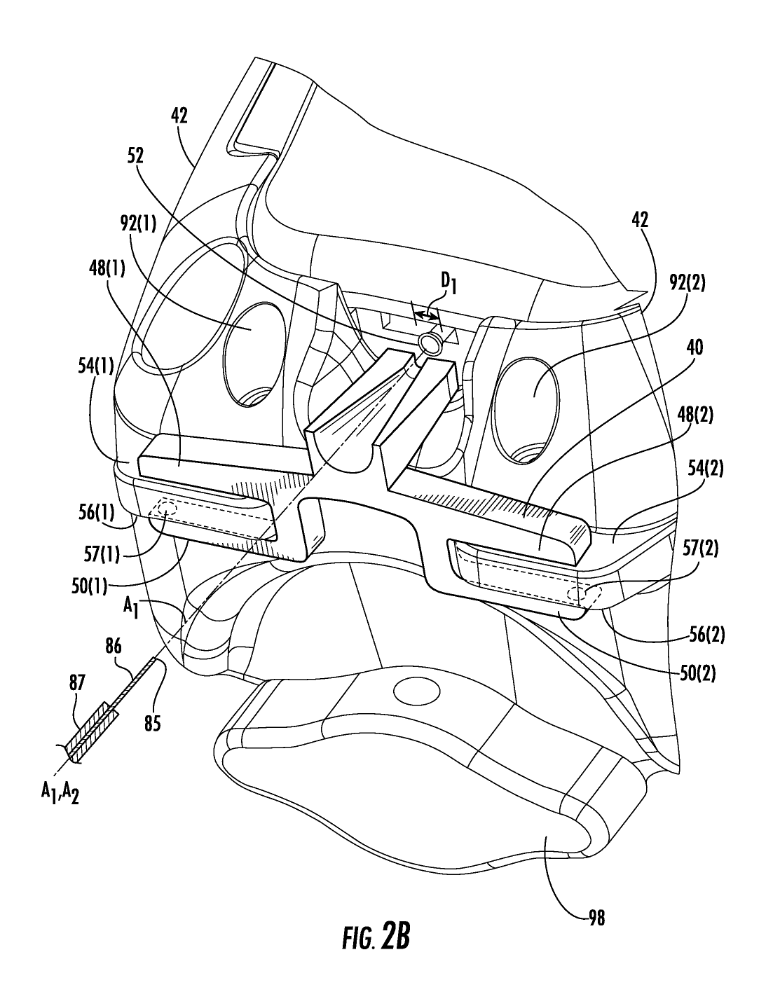

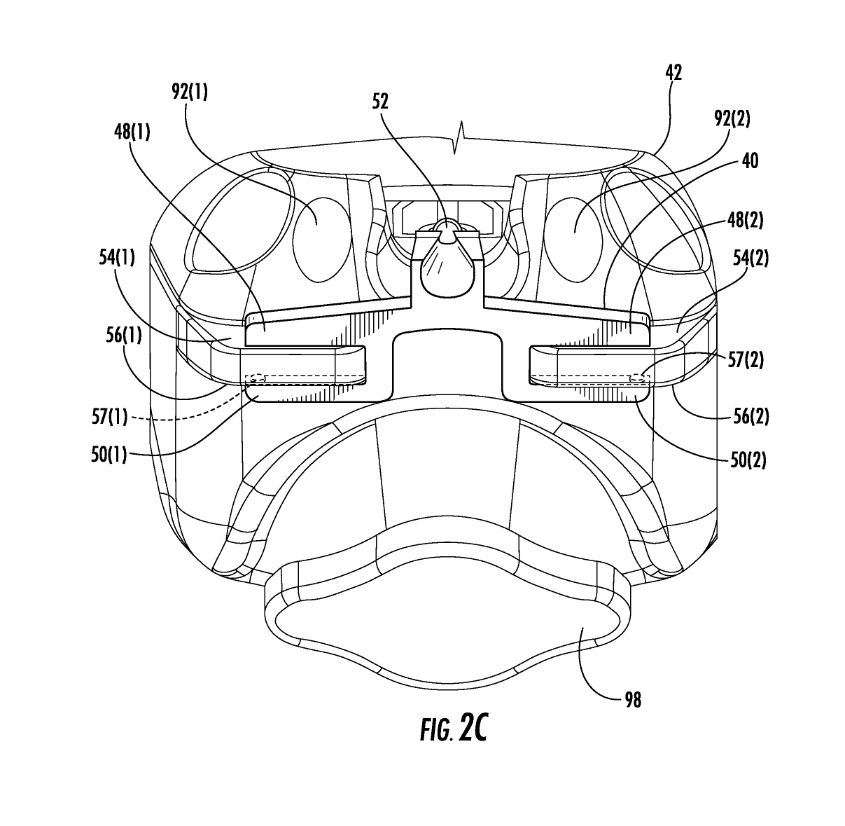

In this regard, FIG. 2A is a top view of an exemplary detachable optical fiber guide apparatus 40 adjacent to a splice connector installation tool 42. In this explanatory embodiment, the splice connector installation tool 42 is useful for a UniCam® field-installable connector commercially available from Corning Cable Systems, LLC of Hickory, N.C. The detachable optical fiber guide apparatus 40 includes various features seen from the top view including a fiber guide 44 and an attachment member 46. The attachment member 46 may include first extension members 48(1), 48(2) and second extension members 50(1), 50(2) (see FIGS. 2B and 2C). The attachment member 46 may be configured to be attached to the splice connector installation tool 42 to align the fiber guide 44 with a fiber entry 52 of a fiber optic connector 90 installed within the splice connector installation tool 42. In order to align the fiber guide 44, the first extension members 48(1), 48(2) may be configured to abut first exterior surfaces 54(1), 54(2) of the splice connector installation tool 42, and the second extension members 50(1), 50(2) may be configured to abut the second exterior surfaces 56(1), 56(2) of the splice connector installation tool 42 as shown in FIGS. 2B and 2C. The first extension members 48(1), 48(2) and second extension members 50(1), 50(2) may have dimples 57(1), 57(2) attached to form the abutment with the first exterior surfaces 54(1), 54(2) and the second exterior surfaces 56(1), 56(2).

The dimples 57(1), 57(2) may be made of a soft flexible material, for example silicone. In some embodiments, the dimples 57(1), 57(2) may be made of the same material as the first extension members 48(1), 48(2) and the second extension members 50(1), 50(2), for example, thermoplastic, to be attached using a mechanical fit to the splice connector installation tool 42. The dimples 57(1), 57(2) may be adhered to the first extension members 48(1), 48(2) and the second extension members 50(1), 50(2) with an adhesive, for example epoxy, to form a tight slip-free abutment or formed integrally therewith. The dimples 57(1), 57(2) may help prevent the detachable optical fiber guide apparatus 40 from becoming misaligned by slipping after being attached.

With continuing reference to FIG. 2A, the fiber guide 44 may include a recess 58 defining an exit opening 60 having a first cross-sectional area CS₁ and disposed on a first end 62 of the fiber guide 44. The fiber guide 44 may also include an entry opening 64 having a second cross-sectional area CS₂ larger than the first cross-sectional area CS₁. The entry opening 64 may be disposed on a second end 66 of the fiber guide 44. The recess 58 may include one or more recess surfaces 68 disposed at a suitable angle such as within twenty (20) degrees from an axis A₁ of the splice connector installation tool 42. Ideally the recess surfaces 68 may be disposed within fifteen (15) degrees of the axis A₁ to reduce debris, but other angles are possible. The recess surfaces 68 may include a bottom recess surface portion 70 disposed at a suitable angle from axis A₁ such as within two (2) degrees of the axis A₁ of the splice connector installation tool 42.

As discussed above, the detachable optical fiber guide apparatus 40 may be attached to the splice connector installation tool 42. Some non-limiting features of the splice connector installation tool 42 which appear in the top view of FIG. 2A may include the housing 72, termination status indicators such as unacceptable termination signal 74 and/or acceptable termination signal 76, cam actuator 78, and a visual fault locator system 80. The housing 72 may form an internal cavity 82 within which a mechanical device 84 and the visual fault locator system 80 may be disposed.

The mechanical device 84 may be utilized to perform a splice termination of an end portion 85 of an optical fiber 86 with a stub optical fiber 88 of the fiber optic connector 90. The optical fiber 86 may include a buffer 87 for protection and/or stress isolation or not depending on the cable and/or connector design. When the splice termination of the optical fiber 86 and the stub optical fiber 88 is completed then the optical fiber 86 and the stub optical fiber 88 are optically coupled by way of a mechanical splice. The cam actuator 78 twists a portion of the fiber optic connector 90 called a cam member 79 of the fiber optic connector 90 to perform the splice termination. FIG. 2A depicts the splice connector installation tool 42 with the fiber optic connector 90 installed and the stub optical fiber 88 internal of the fiber optic connector 90 shown in phantom lines.

Determining whether a termination of an optical fiber 86 has been properly performed can be important. In this regard in this embodiment, the visual fault locator system 80, discussed above, may be located in the internal cavity 82 of the housing 72 and determines whether the splice termination is properly performed. The visual fault locator system 80 may comprise one or more optical lenses and light sensors to determine if the quality and intensity of light conveyed between the optical fiber 86 and the stub optical fiber 88 meet performance specifications. The unacceptable termination signal 74 or the acceptable termination signal 76 (i.e., termination status indicators) may illuminate to communicate whether the splice termination is properly performed. The unacceptable termination signal 74 and the acceptable termination signal 76 may be located in second recesses 92(1), 92(2) respectively within the housing 72.

With continuing reference to FIGS. 2B and 2C, the first exterior surfaces 54(1), 54(2) and the second exterior surfaces 56(1), 56(2) discussed above may also be included as part of the housing 72. The housing 72 may also include a housing recess 94 forming a housing opening 96 to enable the optical fiber 86 to be inserted into the fiber entry 52. The fiber entry 52 may have a width D₁ (FIG. 2B). In one embodiment the width D₁ may be two (2) millimeters, but other suitable widths are possible. The splice connector installation tool 42 may include a splice activation handle 97 to be engaged to initiate optical coupling between the optical fiber 86 and the stub optical fiber 88 such as by rotating a cam actuator. As shown in FIGS. 2A and 2B, the splice connector installation tool 42 may include a crimp knob 98 to deform the crimp tube of the fiber optic connector 90 after the acceptable termination signal 76 is received if desired. Access and operation of the crimp knob 98 may continue when the detachable optical fiber guide apparatus 40 is attached to the splice connector installation tool 42. In other words, the optical fiber guide apparatus 40 does not impede the operation of the installation tool 42.

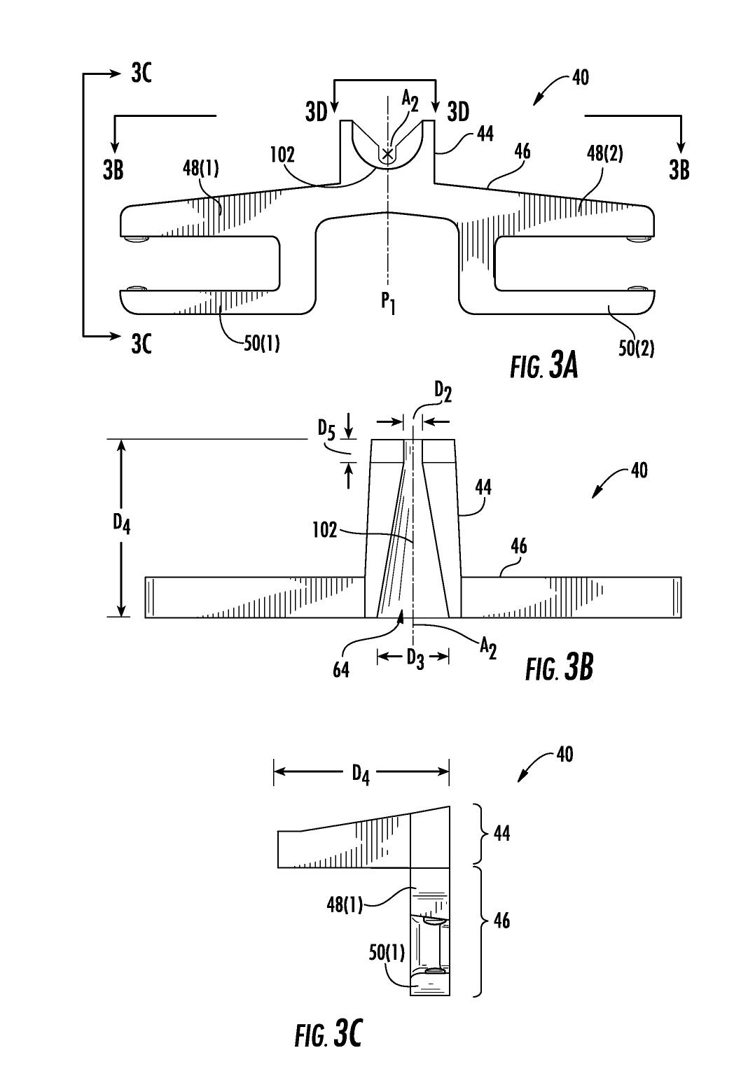

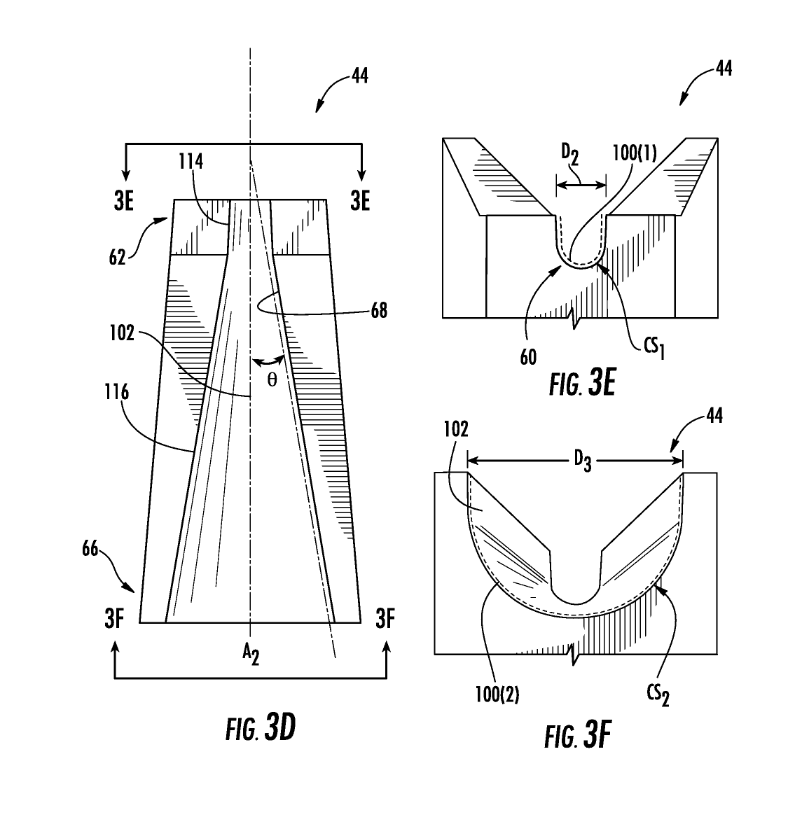

FIGS. 3A through 3F depict additional features of the detachable optical fiber guide apparatus 40. These additional features include the fiber guide 44 and attachment member 46. The fiber guide 44 may be integral to the attachment member 46. Integrating the fiber guide 44 and the attachment member 46 may reduce manufacturing expense by reducing the number of components and may reduce installation time during use by eliminating assembly steps or tasks. For example, with reference to FIGS. 3A through 3F, the fiber guide 44 may include the recess 58 which may guide the optical fiber 86 to the fiber entry 52 of the fiber optic connector 90 when the fiber optic connector 90 is installed within the splice connector installation tool 42. The recess 58 may also define the exit opening 60 (FIG. 3E) having the first cross-sectional area CS₁ and disposed on the first end 62 of the fiber guide 44. A width D₂ (FIG. 3B) in one embodiment may be one (1) millimeter, but other suitable widths are possible. The width D₂ of the exit opening 60 may be smaller than the width D₁ of the fiber entry 52 of the fiber optic connector 90 to provide sufficient precision for the optical fiber 86 to enter the fiber entry 52. The first cross-sectional area CS₁ may have a curvilinear shape 100(1) (FIG. 3E) to avoid sharp corners that may catch the optical fiber 86 before the optical fiber 86 departs from the fiber guide 44. Also, the curvilinear shape 100(1) may facilitate an easier operation to make smooth edges, otherwise sharp edges may damage the optical fiber 86 or be a ready source of debris to contaminate the optical fiber 86. The curvilinear shape 100(1) may also enable the recess 58 to be more easily cleaned to remove debris.

The fiber guide 44 may also include the entry opening 64 which may permit the optical fiber 86 to enter the recess 58. The entry opening 64 may be disposed on the second end 66 of the fiber guide 44. The entry opening 64 may have the second cross-sectional area CS₂ having a width of D₃ (FIG. 3B) and a curvilinear shape 100(2) (FIG. 3F). The second cross-sectional area CS₂ may be larger than the first cross-sectional area CS₁ as the width D₃ may be larger than the width D₂.

There are additional features of the recess 58 which may be a distance D₄ along the longitudinal axis A₂. Embodiments of the recess 58 may include the distance D₄ no less than about five (5) millimeters long and no more than about twenty-five (25) millimeters long, as a non-limiting example, but other lengths are possible. A distance D₄ cannot be too short because the width D₂ of the exit opening 60 may be restricted by the width D₁ of the fiber entry 52, the maximum theta (θ) to allow tolerable damage to the optical fiber 86 and debris generation, and the width D₃ of the entry opening 64 to allow the optical fiber 86 to be easily inserted into the recess 58 of the fiber guide 44. A maximum length of the distance D₄ is limited by a geometric plane (not shown) defined by the crimp knob 98 and the first exterior surfaces 54(1), 54(2) and second exterior surfaces 56(1), 56(2) that are used to stand the splice connector installation tool 42 vertically. Further, the distance D₄ cannot be too long because the optical fiber 86 may be more difficult to control at the first end 62 of the fiber guide 44 when the first end 62 becomes distant from the second end 66.

Two symmetrical elements for 48, 50, 54, 56, 57, and 92 are shown in the embodiment depicted in FIGS. 2A through 3C but other embodiments could also include one, or more than two of these elements and they may be asymmetrical if desired.

The recess 58 may include the one or more recess surfaces 68 which may be optionally plated with a metallic plating material 102 to prevent the optical fiber 86 from stopping along the recess 58. The metallic plating material 102 allows an inexpensive material, for example, thermoplastic, to be used to manufacture an interior of the detachable optical fiber guide apparatus 40 to save manufacturing costs. In some embodiments the detachable optical fiber guide apparatus 40 may be wholly made of metal, for example a nickel alloy or other suitable material.

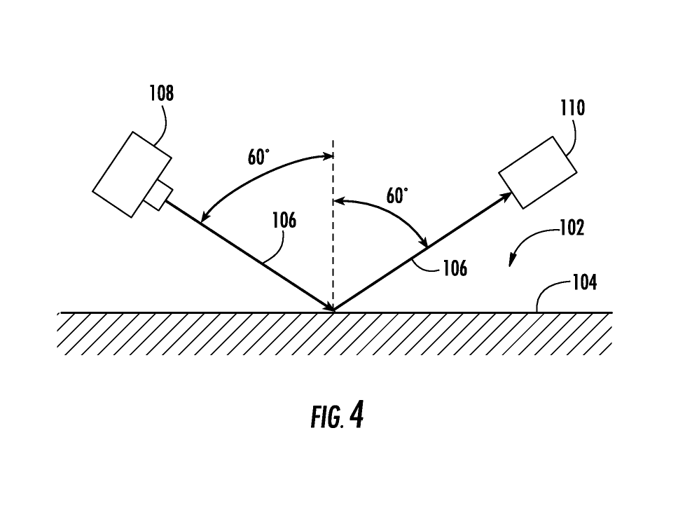

As stated, the fiber guide 44 may optionally be fully or at least partially plated with the metallic plating material 102. The metallic plating material 102 may be a matte-finish material 104 comprising nickel and having a dark color, for example, black. As schematically illustrated in FIG. 4, the matte-finish material 104 may reflect no more than five (5) percent of a visual-light beam 106 radiating from a light source 108 reflected sixty (60) degrees from perpendicular to the matte-finish material 104 as measured by a light-intensity measurement device 110. The visual-light beam 106 may comprise electromagnetic radiation having a wavelength of more than 380 nanometers and less than 740 nanometers. An operator may be better able to insert the optical fiber 86 through the recess 58 and into the fiber entry 52 when the optical fiber 86 is easily seen. The optical fiber 86 is more easily seen against the matte-finish material 104 because limited glare from reflection from the matte-finish material 104 provides a high contrast.

The matte-finish material 104 may also be damage-resistant, forming a surface configured to reduce or not cause debris when in abutment with the optical fiber 86. The debris may be caused when the optical fiber 86 scratches the matte-finish material 104. Debris may be generated when the optical fiber 86 contacts the matte-finish material 104 of the recess 58. The debris generation may be controlled by a number of factors including a hardness of the matte-finish material 104 relative to the optical fiber 86, and/or the geometry of the recess 58. The metallic plating material 102 may not have too low of a hardness compared to the optical fiber 86 or the metallic plating material 102 will easily deform upon contact with the optical fiber 86 and cause debris. The optical fiber 86 may have a Mohs scale of hardness of about seven (7) as one non-limiting example. As an example, the metallic plating material 102 may have a Mohs scale of hardness of no more than seven (7) and no less than three (3), but other hardness levels are possible beside this non-limiting example. The ideal hardness for the metallic plating material 102 may be four (4) considering performance and cost issues. The metallic plating material 102 may also have a surface roughness of less than thirteen (13) microinches as a non-limiting example. The relative hardness of the metallic plating material 102 and low relative surface roughness discourages the generation of debris upon contact with the optical fiber 86.

The rate of debris generation may be low at an angle of attack of zero (0) degrees when the optical fiber is parallel to the metallic plating material 102 of the recess 58. However, as the optical fiber 86 approaches a position perpendicular to the metallic plating material 102 when the angle of attack is ninety (90) degrees, the rate of debris generation increases. Tables 1A and 1B shown below depict empirical data showing observations of debris generation and the optical fiber 86. In Tables 1A and 1B, seven (7) different optical fibers 86 were used for seven different angles of attack from ten (10) degrees to seventy (70) degrees to contact or “strike” the metallic plating material 102. Each of the seven (7) different optical fibers 86 experienced five (5) cycles of strikes to the metallic plating material 102 at a given angle of attack. Observations were recorded during each cycle in Table 1A (Non-Limiting Examples of Condition of Optical Fiber and Level of Debris For Angles of Attack From Ten (10) to Forty (40) Degrees) or Table 1B (Non-Limiting Examples of Condition of Optical Fiber and Level of Debris For Angles of Attack From Fifty (50) to Seventy (70) Degrees) regarding the damage to the optical fiber 86 and the recess 58, and the debris generated each cycle. Also, at the beginning of each cycle the optical fiber 86 was cleaved and both the recess 58 and the optical fiber 86 were cleaned. The empirical data shows that angles of attack less than twenty (20) degrees have minimum debris generation and minimum damage to the optical fiber 86.

TABLE 1A
Non-Limiting Examples of Condition of Optical Fiber and Level of
Debris For Angles of Attack From Ten (10) to Forty (40) Degrees

| | Condition of Optical Fiber and Level of Debris | | | |
|---|---|---|---|---|
| | For Each Angle of Attack | | | |
| Fiber Optic | 10 | 20 | 30 | 40 |
| Strikes | Degrees | Degrees | Degrees | Degrees |
| First | No change | Debris about ½ | Small deposit | Debris scattered |
| | | radius inward and | ⅓ of radius | across one side |
| | | about ½ radius | | |
| | | width | | |
| Second | Small deposit of | Debris with small | Small deposit | Large deposit |
| | debris added from | width but extends | ½ of radius | about ⅔ radius |
| | edge to ¼ radius | ⅚ of the way to | | inward |
| | | core | | |
| Third | Small deposit of | Small debris ½ | Small deposit | Large amount of |
| | debris added from | radius inward | ½ of radius | debris scattered |
| | edge to ¼ radius | | | across surface |
| Fourth | Small deposit of | Large deposit | Small deposit | Large deposit |
| | debris added from | with string of | ⅓ of radius | ½ radius |
| | edge to ⅓ radius | powder across | | inward |
| | | fiber | | |
| Fifth | Small deposit of | Small debris ½ | 2 large deposits | Large deposit |
| | debris added from | radius inward | with debris | almost to core |
| | edge to ½ radius | | scattered across | and scattered |
| | | | radial surface | across radial |
| Observations of | Has scratches from | Vertical scratches | No scratches | Scratches across |
| fiber guide | rear top diagonal | from mold line to | | top of front end |
| before first | toward front | top | | |
| optical fiber | bottom | | | |
| strike | | | | |
| Observations of | No discernable | No discernable | No discernable | 2.5 scratches |
| fiber guide after | change | change | change | cross the |
| fifth optical | | | | midsection, most |
| fiber strike | | | | likely from same |
| | | | | fiber |

TABLE 1B
Non-Limiting Examples of Condition of Optical Fiber and Level of Debris
For Angles of Attack From Fifty (50) to Seventy (70) Degrees

| | Condition of Optical Fiber and Level of Debris | | |
|---|---|---|---|
| | for Each Angle of Attack | | |
| Fiber Optic | 50 | 60 | 70 |
| Strikes | Degrees | Degrees | Degrees |
| First | Debris scattered all | Debris deposit to | ½ of fiber destroyed |
| | the way to core and | center of fiber and | |
| | across radially | small deposit across | |
| Second | Small deposit ½ | Destroyed across | ⅓ destroyed |
| | radius inward | entire fiber with | |
| | | large deposit on one | |
| | | end | |
| Third | Piece of fiber | ⅓ of fiber | Large area of debris |
| | missing, debris | destroyed | with small deposit |
| | scattered to core | | across |
| Fourth | Small deposit ⅔ | A little more | Debris all around |
| | radius inward with | destroyed than third | surface of fiber |
| | tiny deposit adjacent | cleave | |
| Fifth | Large deposit inward | Nearly ½ of fiber | ½ of fiber destroyed |
| | to core | destroyed | inwardly with radial |
| | | | surface damage |
| Observations of fiber | Large diagonal | Divot at rear mid; | Vertical scratches at |
| guide before first | scratch at top | scratches extend | front |
| optical fiber strike | | from front | |
| | | diagonally | |
| Observations of fiber | No discernable | Multiple scratches | Multiple scratches |
| guide after fifth | change | across in two | were fibers stuck to |
| optical fiber strike | | different places | device |

Using the information from Tables 1A and 1B, where a smaller angle of attack reduces debris and optical fiber damage. In this regard, as a non-limiting example, the recess 58 may include the one or more recess surfaces 68 disposed within twenty (20) degrees from the longitudinal axis A₁ of the splice connector installation tool 42, but other angles are possible. FIG. 3D illustrates an exemplary angular measurement of the recess surfaces 68 as angle theta (θ) from a longitudinal axis A₂ of the fiber guide 44. The longitudinal axis A₂ enters the recess 58 at the entry opening 64 and exits the recess 58 at the exit opening 60. When the fiber guide 44 is aligned with the splice connector installation tool 42, then the axis A₁ and the longitudinal axis A₂ are aligned as depicted in FIG. 2B. Ideally, the recess surfaces 68 may be disposed within fifteen (15) degrees of the axis A₁ to further reduce debris and damage to the optical fiber 86. However, not every portion of the recess surfaces 68 may have the same angular disposition to the longitudinal axis A₂ in this embodiment. In other words, compound surfaces/angles are possible with the concepts disclosed. When axis A₁ is aligned with longitudinal axis A₂ then the detachable optical fiber guide apparatus is aligned with the splice connector installation tool 42. For example, in FIG. 3D a portion 114 of recess surfaces 68 having a length D₅ along the axis A₁ may be parallel (0 degrees) to the axis A₁, yet portion 116 of the recess surfaces 68 may be fifteen (15) degrees.

Moreover, the recess surfaces 68 may include the bottom recess surface portion 70 disposed within four (4) degrees of the axis A₁ of the splice connector installation tool 42, or preferably no more than two (2) degrees, as non-limiting examples. In embodiments where the recess surfaces 68 may have the cross sections CS₁, CS₂ in the curvilinear shape 100, then the bottom recess surface portion 70 is a portion of the recess surfaces 68 that is within a vertical geometric plane P₁ (see FIG. 3A) coincident with the axis A₁. The angular disposition of the bottom recess surface portion 70 may limit the change in vertical direction experienced by the optical fiber 86. This angular disposition also makes it easier for the optical fiber 86 to be inserted into the fiber entry 52 by reducing an opportunity to misalign the optical fiber 86 vertically with respect to the fiber entry 52.

With continuing reference to FIGS. 3A through 3C, the attachment member 46 also has additional features. The attachment member 46 supports the fiber guide 44 and may be configured to be attached to a splice connector installation tool 42 to align the fiber guide 44 with the fiber entry 52 of the fiber optic connector 90 installed within the splice connector installation tool 42 (FIG. 2B). The attachment member 46 may be configured for tool-less attachment and tool-less detachment from the splice connector installation tool 42. Thus, the attachment member 46 may be attached and detached manually, wherein the attachment member 46 may include an extension member for toolless attachment to a feature of the housing 72 of the splice connector installation tool 42. For example, in one embodiment the attachment member 46 may include the at least one first extension member 48 configured to abut the first exterior surface 54 of the splice connector installation tool 42. The attachment member 46 may also include the at least one second extension member 50 configured to abut a second exterior surface 56 of the splice connector installation tool 42 opposite the first exterior surface 54. In this regard, the first exterior surface 54 and the second exterior surface 56 may also be disposed between the first extension member 48 and the second extension member 50.

Now that the features of the detachable optical fiber guide apparatus 40 have been discussed, an exemplary method 118 for splicing the optical fiber 86 in the fiber optic connector 90 may be disclosed in FIG. 5. In the first task of the process, the fiber optic splice connector installation tool may be provided comprising a housing (block 120 in FIG. 5). The fiber optic connector 90, which includes a stub optical fiber 88, may be installed in the splice connector installation tool 42 wherein the stub optical fiber 88 may be aligned with the axis A₁ of the splice connector installation tool 42 and may be accessible from the fiber entry 52.

Next, the detachable optical fiber guide apparatus 40 is provided including a fiber guide 44 and an attachment member 46 (block 122 in FIG. 5). The fiber guide 44 may then be aligned with a fiber entry 52 of the fiber optic connector 90 installed within the splice connector installation tool 42 by attaching the attachment member 46 to the splice connector installation tool 42 (block 124 in FIG. 5). The attachment member 46 may be attached to the splice connector installation tool 42 by abutting the at least one first extension member 48 of the attachment member 46 with a first exterior surface 54 of the splice connector installation tool 42. Also, the at least one second extension member 50 of the attachment member 46 may be abutted with a second exterior surface 56 of the splice connector installation tool 42 wherein the second exterior surface 56 may be opposite of the first exterior surface 54.

Next, the fiber guide 44 may be cleaned and then attached to the attachment member 46 (block 126 in FIG. 5). The end portion 85 of the optical fiber 86 may then be inserted through the fiber guide 44 and into the fiber optic connector 90 through the fiber entry 52 (block 128 in FIG. 5). The optical fiber 86 may be received in the recess 58 of the fiber guide 44 through the entry opening 64. The recess 58 may define the exit opening 60 having the first cross-sectional area CS₁. The recess 58 may be disposed on the first end 62 of the fiber guide 44. The entry opening 64 may have the second cross-sectional area CS₂ larger than the first cross-sectional area CS₁ and may be disposed on the second end 66 of the fiber guide 44. The second end 66 may be opposite the first end 62. The exit opening 60 may be configured to be disposed adjacent the fiber entry 52 of the fiber optic connector 90 installed within the splice connector installation tool 42.

Moreover, the optical fiber 86 may traverse the fiber guide 44 along a bottom recess surface portion 70 of the recess 58. The bottom recess surface portion 70 may be disposed within two degrees of the axis A₁ of the splice connector installation tool 42. The optical fiber 86 may exit the fiber guide 44 through the exit opening 60 at the first end 62 of the fiber guide 44. The second cross-section CS₂ of the entry opening 64 may be larger than the first cross-section CS₁ of the exit opening 60. Next, the optical fiber 86 may be terminated to a stub optical fiber 88 of the fiber optic connector 90 (block 130 in FIG. 5). Next, the detachable optical fiber guide apparatus 40 may be removed from the splice connector installation tool 42 (block 132 in FIG. 5).

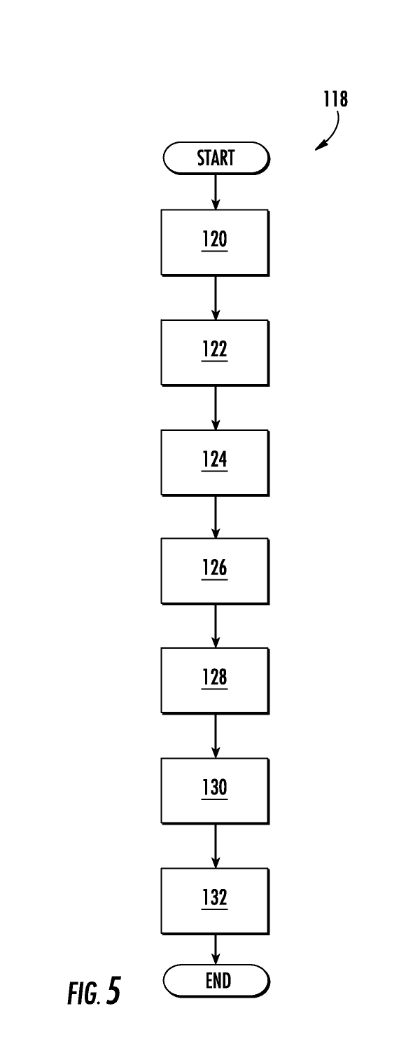

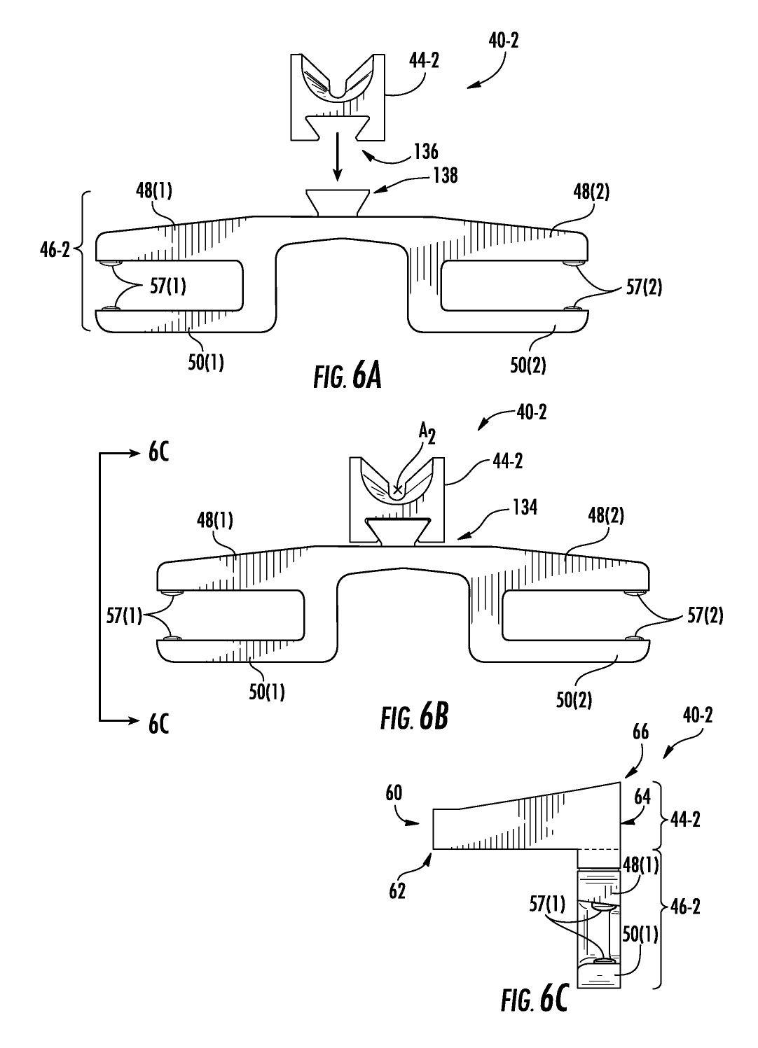

There are other embodiments of the detachable optical fiber guide apparatus 40. A second embodiment is depicted in FIGS. 6A through 6C as detachable optical fiber guide apparatus 40-2 comprising a fiber guide 44-2 and attachment member 46-2. The fiber guide 44-2 may be removably attached to the attachment member 46-2. The fiber guide 44-2 may be adapted to be toollessly attached and toollessly detached from the attachment member 46-2. The fiber guide 44-2 may be removably attached to the attachment member with a sliding dovetail joint 134 including a female portion 136 and a male portion 138. As shown in FIGS. 6A through 6C, the female portion 136 and the male portion 138 may be a part of the fiber guide 44-2 and the attachment member 46-2 respectively. However, the female portion 136 and the male portion 138 may be a part of the attachment member 46-2 and the fiber guide 44-2 respectively.

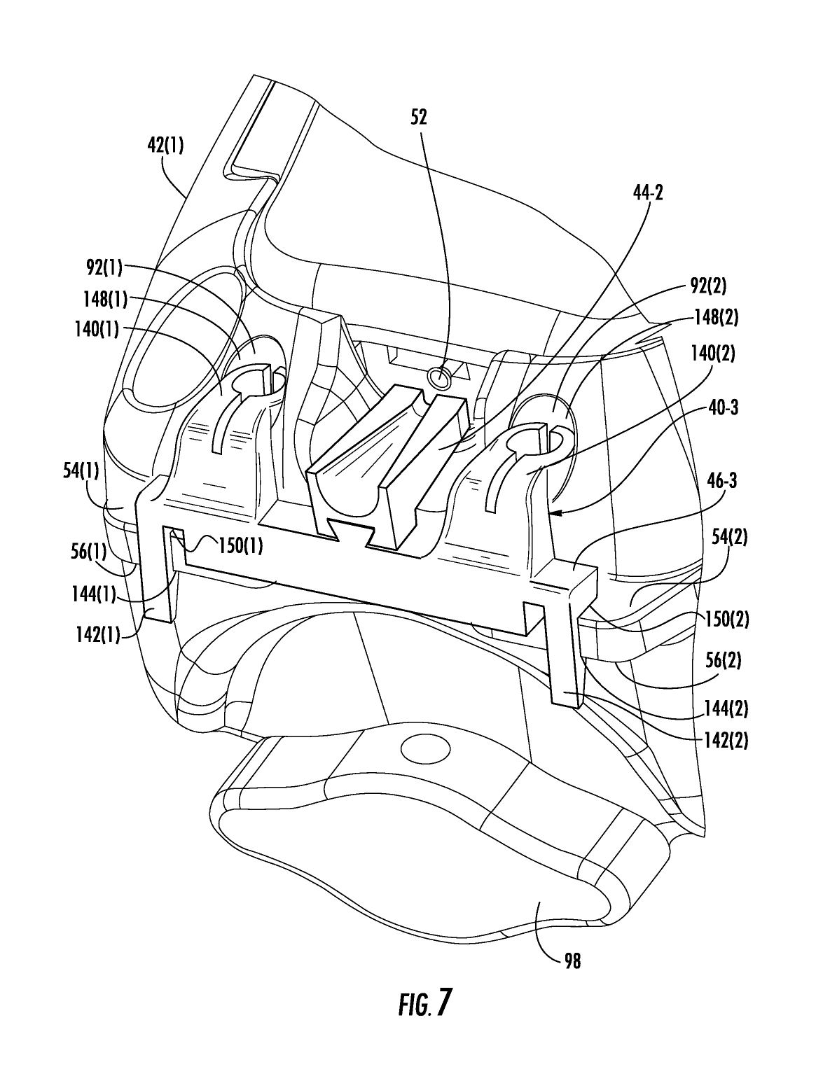

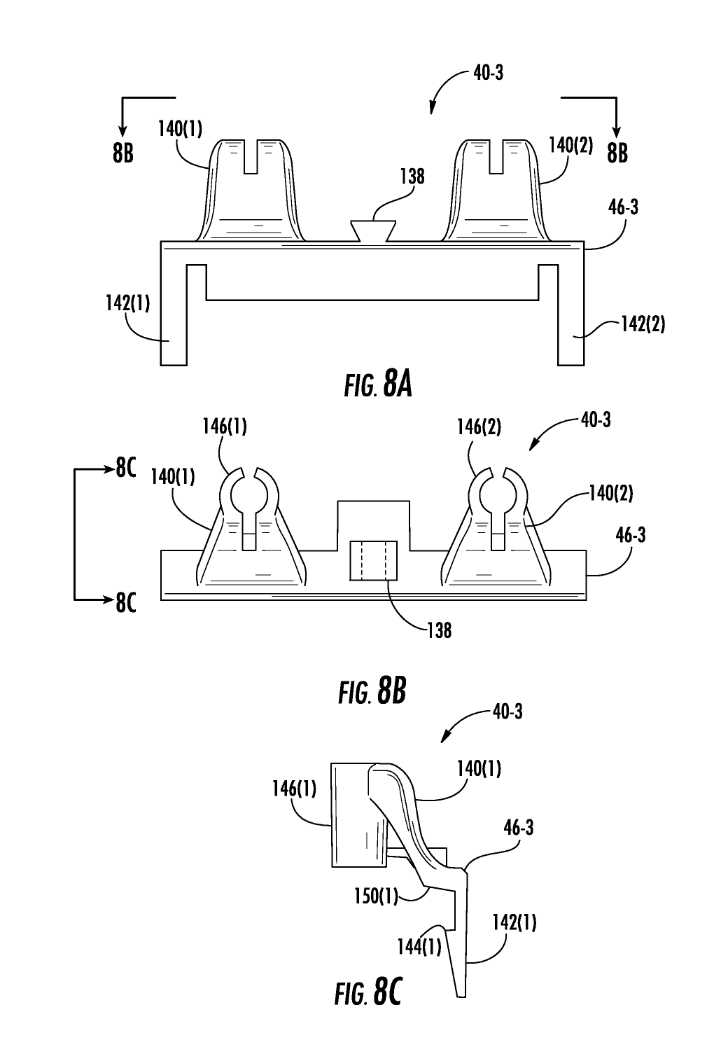

FIG. 7 depicts another embodiment in the form of detachable optical fiber guide apparatus 40-3 attached to the splice connector installation tool 42 and comprising the fiber guide 44-2 and attachment member 46-3. FIGS. 8A through 8C depict details of the detachable optical fiber guide apparatus 40-3.

The fiber guide 44-2 has been disclosed above in an earlier embodiment and so will not be disclosed again to eliminate redundancy.

With continuing reference to FIGS. 7 through 8C, the attachment member 46-3 includes at least one third extension member 140(1), 140(2) supported by second recesses 92(1), 92(2) in the splice connector installation tool 42. The attachment member 46-3 may also include fourth extension members 142(1), 142(2) preventing the third extension members 140(1), 140(2) from departing from the second recesses 92(1), 92(2). The fourth extension members 142(1), 142(2) may include first attachment surfaces 144(1), 144(2) which communicate with the second exterior surfaces 56(1), 56(2) of the splice connector installation tool 42. The third extension members 140(1), 140(2) may remain in the second recesses 92(1), 92(2) as long as upper attachment surfaces 146(1), 146(2) abut second recessed surfaces 148(1), 148(2) of the second recesses 92(1), 92(2). The second recesses 92(1), 92(2) may at least be partially formed by the second recessed surfaces 148(1), 148(2). The depth of the third extension members 140(1), 140(2) within the second recesses 92(1), 92(2) may also be limited. In one non-limiting embodiment, the fourth extension members 142(1), 142(2) may include lower attachment surfaces 150(1), 150(2) that may abut the first exterior surfaces 54(1), 54(2) to prevent the upper attachment surfaces 146(1), 146(2) from extending into the second recesses 92(1), 92(2) beyond a specified depth. It may be undesirable to have the upper attachment surface too deep in the second recesses 92(1), 92(2) because there may be sensitive components in the second recesses 92(1), 92(2); for example, light-emitting diodes may be in the second recesses 92(1), 92(2) that signify whether a satisfactory termination has been achieved between the optical fiber 86 and stub optical fiber 88.

The detachable optical fiber guide apparatus 40-3 may be detached from the splice connector installation tool 42 by pulling the fourth extension members 142(1), 142(2) away from the splice connector installation tool 42. Once the first attachment surfaces 144(1), 144(2) and the lower attachment surfaces 150(1), 150(2) are no longer abutting the second exterior surfaces 56(1), 56(2) and the first exterior surfaces 54(1), 54(2), then the upper attachment surfaces 146(1), 146(2) may be pulled out of the second recesses 92(1), 92(2) and the detachable optical fiber guide apparatus 40-3 may be then detached from the splice connector installation tool 42.

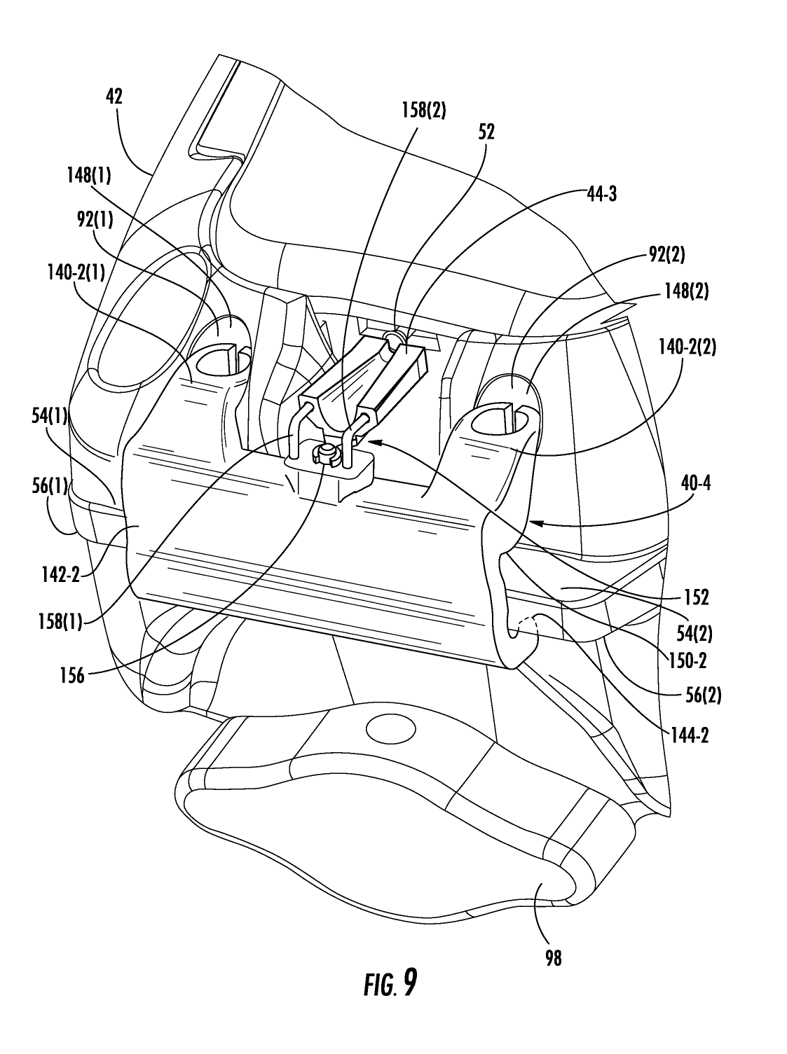

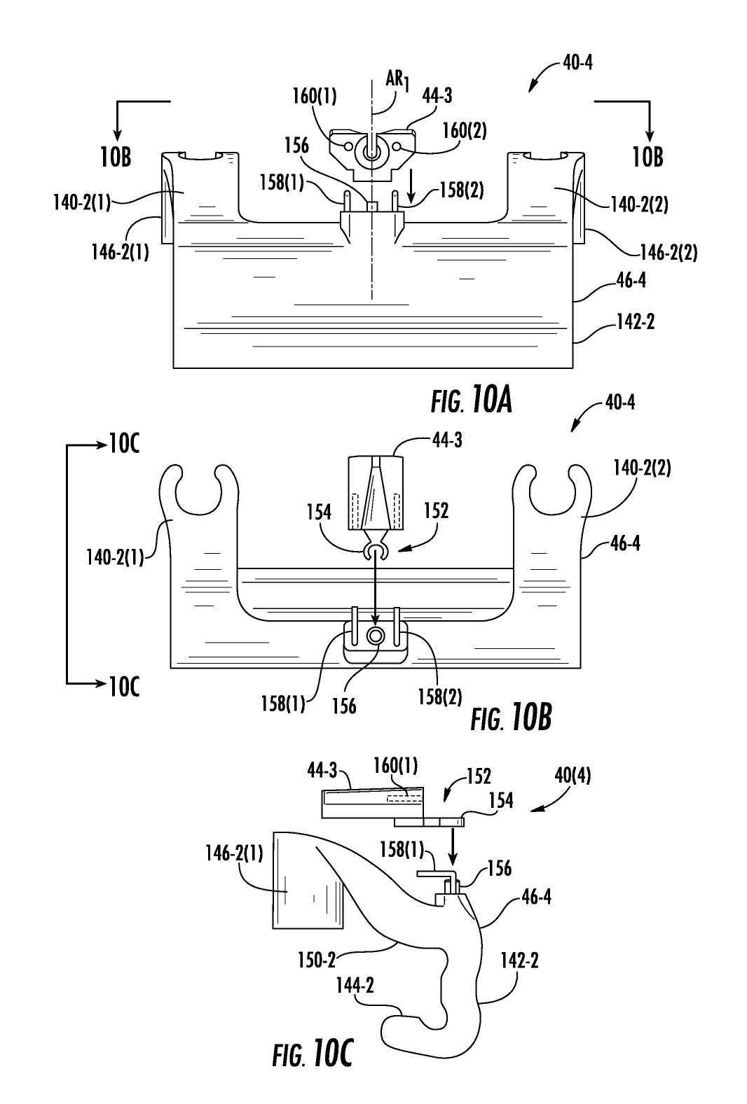

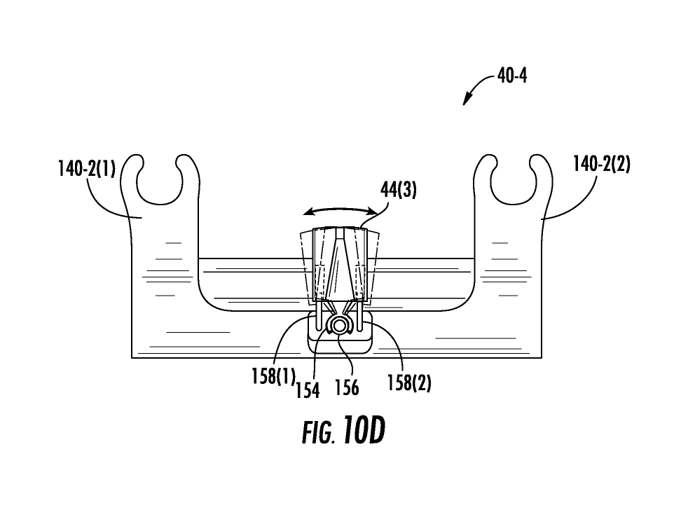

FIG. 9 depicts yet another embodiment in the form of a detachable optical fiber guide apparatus 40-4 attached to the splice connector installation tool 42 and comprising the fiber guide 44-3 and attachment member 46-4. FIGS. 10A through 10C depict details of the detachable optical fiber guide apparatus 40-4.

The fiber guide 44-3 may be removably attached to the attachment member 46-4. In fact, the fiber guide 44-3 may be configured for tool-less attachment and tool-less detachment from the attachment member 46-4. The fiber guide 44-3 may include a pivot connection member 152 removably attached to the attachment member 46-4. The pivot connection member 152 may include an attachment extension 154 of the fiber guide 44-3 disposed at least partially around a cylinder 156 extending from the attachment member 46-4. With only the attachment extension 154 and the cylinder 156, the fiber guide 44-3 may have no restriction on its angular position relative to the attachment member 46-4 as the fiber guide 44-3 may pivot using the attachment extension 154 around the cylinder 156 about an axis of rotation AR₁ coincident with the center axis of the cylinder 156. As a non-limiting embodiment, the attachment member 46-4 may include one or more cantilevered members 158(1), 158(2) extending from the attachment member 46-4. The fiber guide 44-3 may include at least one or more orifice 160(1), 160(2). The cantilevered members 158(1), 158(2) may be configured to be disposed within the at least one orifice 160(1), 160(2) to restrict an angular position of the pivotable connection about the attachment member as shown in FIG. 10D. The angular position of the fiber guide 44-3 may thus be restricted to prevent unwanted movement that may damage the optical fiber.

With continuing reference to FIGS. 9 though 10D, the detachable optical fiber guide apparatus 40-4 may be removably attached to the splice connector installation tool 42. The attachment member 46-4 may include at least one third extension member 140-2(1), 140-2(2) supported by second recesses 92(1), 92(2) in the splice connector installation tool 42. The attachment member 46-4 may also include at least one fourth extension member 142-2 preventing the third extension members 140-2(1), 140-2(2) from departing from the second recesses 92(1), 92(2). The fourth extension member 142-2 may include a first attachment surface 144-2 which may communicate with the second exterior surfaces 56(1), 56(2) of the splice connector installation tool 42. The third extension members 140-2(1), 140-2(2) may remain in the second recesses 92(1), 92(2) as long as upper attachment surfaces 146-2(1), 146-2(2) abut the second recessed surfaces 148(1), 148(2) of the second recesses 92(1), 92(2). The second recesses 92(1), 92(2) may be at least partially formed by the second recessed surfaces 148(1), 148(2). The depth of the third extension members 140-2(1), 140-2(2) within the second recesses 92(1), 92(2) may also be limited. In one non-limiting embodiment, the fourth extension member 142-2 may include a lower attachment surface 150-2 that may abut the first exterior surfaces 54(1), 54(2) to prevent the upper attachment surfaces 146-2(1), 146-2(2) from extending into the second recesses 92(1), 92(2) beyond a specified depth. It may be undesirable to have the upper attachment surface too deep in the second recesses 92(1), 92(2) because there may be sensitive components in the second recesses 92(1), 92(2); for example, light-emitting diodes may be in the second recesses 92(1), 92(2) that signify whether a satisfactory termination has been achieved between the optical fiber 86 and stub optical fiber 88.

Two symmetrical elements for 48, 50, 54, 56, 57, 92, 140, 140-2, 142, 144, 146, 146-2, 148, 150, 158, and 160 are shown in the embodiments depicted in FIGS. 6A through 10D, but other embodiments could also include one or more than two of each of these elements or that may be asymmetrical.

The connector installation tool, the detachable optical fiber guide apparatus, and methods described herein to insert and guide the optical fiber to the stub fiber within the fiber optic connector installed within the splice connector installation tool are applicable to any pair of interconnected optical fibers, and more particularly, between a field optical fiber and an optical fiber of any fiber optic splice connector, including a single fiber or multi-fiber fusion splice or mechanical splice connector. Examples of typical single fiber mechanical splice connectors are provided in U.S. Pat. Nos. 4,755,018; 4,923,274; 5,040,867; and 5,394,496. Examples of typical multi-fiber mechanical splice connectors are provided in U.S. Pat. Nos. 6,173,097; 6,379,054; 6,439,780; and 6,816,661.

As used herein, it is intended that the terms “fiber optic cables” and/or “optical fibers” include all types of single mode and multi-mode light waveguides, including one or more optical fibers that may be up-coated, colored, buffered, ribbonized and/or have other organizing or protective structure in a cable such as one or more tubes, strength members, jackets or the like. The optical fibers disclosed herein can be single mode or multi-mode optical fibers. Likewise, other types of suitable optical fibers include bend-insensitive optical fibers, or any other expedient of a medium for transmitting light signals. An example of a bend-insensitive, or bend resistant, optical fiber is ClearCurve® Multimode fiber commercially available from Corning Incorporated of Corning, N.Y. Suitable fibers of this type are disclosed, for example, in U.S. Patent Application Publication Nos. 2008/0166094 and 2009/0169163, the disclosures of which are incorporated herein by reference in their entireties.

As used herein, the term “splice connector installation tool” does not qualify as a tool with regard to the term “tool-less.”

Many modifications and other embodiments not set forth herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims. It is intended that the embodiments cover the modifications and variations of the embodiments provided they come within the scope of the appended claims and their equivalents. Although specific terms are employed herein, they are used in a generic and descriptive sense only and not for purposes of limitation.

What is claimed is:

1. A detachable optical fiber guide apparatus configured to guide an optical fiber into a fiber optic connector installed within a splice connector installation tool, comprising:
a fiber guide configured to receive and guide an optical fiber; and
an attachment member supporting the fiber guide, the attachment member configured to be attached to a splice connector installation tool to align the fiber guide with a fiber entry of a fiber optic connector installed within the splice connector installation tool,
wherein the fiber guide comprising a recess defining an exit opening having a first cross-sectional area and an entry opening opposite the exit opening and having a second cross-sectional area larger than the first cross-sectional area, the exit opening configured to be disposed adjacent the fiber entry,
wherein the entry opening is configured to receive the optical fiber and to guide the optical fiber to and through the exit opening into the fiber entry.

2. The detachable optical fiber guide apparatus of claim 1, wherein the recess includes one or more recess surfaces disposed within twenty (20) degrees from an axis of the splice connector tool.

3. The detachable optical fiber guide apparatus of claim 2, wherein the one or more recess surfaces include a bottom recess surface disposed within four (4) degrees of the axis of the splice connector tool.

4. The detachable optical fiber guide apparatus of claim 1, wherein the fiber guide is at least partially plated with a plating material.

5. The detachable optical fiber guide apparatus of claim 4, wherein the metallic plating material has a surface roughness less than thirteen (13) microinches.

6. The detachable optical fiber guide apparatus of claim 1, wherein the fiber guide is at least partially plated with a plating material including a matte-finish which reflects no more than five (5) percent of a visual light beam reflected sixty (60) degrees from perpendicular to the surface.

7. The detachable optical fiber guide apparatus of claim 1, wherein the fiber guide comprises a thermoplastic material which is at least partially plated with a plating material.

8. The detachable optical fiber guide apparatus of claim 4, wherein the plating material includes nickel.

9. The detachable optical fiber guide apparatus of claim 1, wherein the fiber guide comprises a metal material.

10. The detachable optical fiber guide apparatus of claim 1, wherein the fiber guide is integral to the attachment member or removably attached to the attachment member.

11. The detachable optical fiber guide apparatus of claim 1, wherein the fiber guide is toollessly attached to the attachment member and is configured for tool-less detachment from the attachment member.

12. The detachable optical fiber guide apparatus of claim 1, wherein the fiber guide further comprising a pivot connection member removably attached to the attachment member.

13. The detachable optical fiber guide apparatus of claim 12, wherein the pivot connection member comprises an attachment extension of the fiber guide disposed at least partially around a cylinder extending from the attachment member.

14. The detachable optical fiber guide apparatus of claim 13, wherein the fiber guide includes at least one orifice, and the attachment member includes at least one cantilevered member extending from the attachment member and configured to be disposed within the at least one orifice to restrict an angular position of the pivotable connection about the attachment member.

15. The detachable optical fiber guide apparatus of claim 1, wherein the attachment member is configured for tool-less attachment and tool-less detachment from the splice connector installation tool.

16. The detachable optical fiber guide apparatus of claim 15, wherein the attachment member comprises an extension member configured for toolless attachment to a housing feature of the splice connector installation tool.

17. The detachable optical fiber guide apparatus of claim 16, wherein the housing feature is a thread-less recess in the housing feature or a protrusion of the housing.

18. The detachable optical fiber guide apparatus of claim 15, wherein the attachment member comprises:
at least one first extension member configured to abut a first exterior surface of the splice connector installation tool; and
at least one second extension member configured to abut a second exterior surface of the splice connector installation tool opposite the first exterior surface.

19. The detachable optical fiber guide apparatus of claim 15, wherein the attachment member comprises at least one third extension member configured to be supported by a second recess of the splice connector installation tool.

20. The detachable optical fiber guide apparatus of claim 19, wherein the attachment member comprises at least one fourth extension member configured to prevent the at least one third extension member from departing from the second recess in the housing.

21. The detachable optical fiber guide apparatus of claim 20, wherein the at least one fourth extension member is configured to communicate with a third surface on the splice connector installation tool to protect the at least one third extension member from departing from the second recess.

22. The detachable optical fiber guide apparatus of claim 21, wherein the at least one fourth extension member including at least one upper attachment surface configured to abut at least one recessed surface of the second recess of the splice connector installation tool, and the at least one second extension member including at least one lower attachment surface configured to abut the second exterior surface of the splice connector installation tool.

23. An optical fiber termination system, comprising:
a splice connector installation tool including
a housing forming an internal cavity, the housing comprising a first external surface and a second external surface, and
a mechanical device at least partially disposed within the internal cavity configured to perform a splice termination of an optical fiber and a stub optical fiber of a fiber optic connector; and
a detachable optical fiber apparatus including
a fiber guide configured to receive and guide an optical fiber,
an attachment member supporting the fiber guide, the attachment member configured to be attached to a splice connector installation tool to align the fiber guide with a fiber entry of a fiber optic connector installed within the splice connector installation tool,
the fiber guide comprising a recess defining an exit opening having a first cross-sectional area and an entry opening opposite the exit opening and having a second cross-sectional area larger than the first cross-sectional area, the exit opening configured to be disposed adjacent the fiber entry,
wherein the entry opening is configured to receive the optical fiber and guide the optical fiber to and through the exit opening into the fiber entry.

24. The optical fiber termination system of claim 23, wherein the recess includes one or more recess surfaces disposed within (20) degrees of an axis of the splice connector tool.

25. The optical fiber termination system of claim 24, wherein the one or more recess surfaces include a bottom recess surface disposed within four (4) degrees of the axis of the splice connector tool.

26. The optical fiber termination system of claim 23, wherein the fiber guide is at least partially plated with a plating material.

27. The optical fiber termination system of claim 23, wherein the fiber guide is at least partially plated with a plating material including a matte-finish which reflects no more than five (5) percent of a visual light beam reflected sixty (60) degrees from perpendicular to the surface.

28. The optical fiber termination system of claim 23, wherein the fiber guide is integral to the attachment member.

29. The optical fiber termination system of claim 23, wherein the fiber guide is removably attached to the attachment member.

30. The optical fiber termination system of claim 23, wherein the attachment member is configured for tool-less attachment and tool-less detachment from the splice connector installation tool.

31. The optical fiber termination system of claim 30, wherein the attachment member comprises:
at least one first extension member abutting the first exterior surface of the splice connector installation tool; and
at least one second extension member abutting the second exterior surface of the splice connector installation tool, the second exterior surface opposite the first exterior surface.

32. The optical fiber termination system of claim 30, wherein the attachment member comprises at least one third extension member supported by a second recess in the splice connector installation tool.

33. The optical fiber termination system of claim 32, wherein the attachment member comprises at least one fourth extension member preventing the at least one third extension member from departing from the second recess.

34. The optical fiber termination system of claim 33, wherein the at least one fourth extension member includes a first attachment surface which communicates with the second exterior surface to prevent the at least one third extension member from departing from the second recess.

35. The optical fiber termination system of claim 34, wherein the at least one third extension member including at least one upper attachment surface abutting at least one recessed surface of the second recess.

36. The optical fiber termination system of claim 35, wherein the at least one fourth extension member including at least one lower attachment surface abutting the second exterior surface of the splice connector installation tool.

37. A method for splicing an optical fiber to a stub optical fiber in a fiber optic connector, comprising:
providing a splice connector installation tool comprising a housing;
providing a detachable optical fiber guide apparatus including a fiber guide and an attachment member;
aligning the fiber guide with a fiber entry of a fiber optic connector installed within the splice connector installation tool by attaching the attachment member to the splice connector installation tool;
attaching the fiber guide to the attachment member;
inserting an end portion of an optical fiber through the fiber guide and into the fiber optic connector;
terminating the optical fiber to a stub optical fiber in the fiber optic connector; and
removing the detachable optical fiber guide apparatus from the splice connector installation tool.

38. The method of claim 37, wherein the providing the splice connector installation tool includes:
installing a fiber optic connector including a stub optical fiber in the splice connector installation tool, the stub optical fiber aligned with an axis of the fiber optic splice connector installation tool and accessible from the fiber entry.

39. The method of claim 38, wherein the inserting the end portion of the optical fiber through the fiber guide includes:
receiving the optical fiber in a recess of the fiber guide through an entry opening, the recess defining an exit opening having a first cross-sectional area and disposed on a first end of the fiber guide and the entry opening having a second cross-sectional area larger than the first cross-sectional area and disposed on a second end of the fiber guide opposite the first end, the exit opening configured to be disposed adjacent the fiber entry;
traversing the fiber guide with the optical fiber along a bottom recess surface of the recess, the bottom recess surface is disposed within two degrees of the axis of the fiber optic splice connector installation tool; and
exiting the fiber guide with the optical fiber through an exit opening at the first end of the fiber guide, a second cross-section of the entry opening is larger than the first cross-section of the exit opening.

40. The method of claim 39, wherein the attaching the attachment member to the fiber optic splice installation tool includes:
abutting at least one first extension member of the attachment member with a first exterior surface of the splice connector installation tool and abutting at least one second extension member of the attachment member with a second exterior surface of the splice connector installation tool,
wherein the second exterior surface is opposite of the first exterior surface.

41. The method of claim 40, wherein the attaching the fiber guide to the attachment member includes:
removably attaching the fiber guide to the attachment member with a sliding dovetail joint.

42. The method of claim 41, wherein the fiber guide includes a female portion of the sliding dovetail joint and the attachment member includes the male portion of the sliding dovetail joint.
